(19) United States
(12) Patent Application Publication
(10) Pub. No.: US 2026/0110778 A1
(43) Pub. Date: Apr. 23, 2026

(54) TARGET DISTANCE AND FOCUS TUNING MECHANISM FOR LASER SCANNING SENSOR

(71) Applicant: Lumentum Operations LLC, San Jose, CA (US)

(72) Inventors: Driss TOUAHRI, Ottawa (CA); Alan HNATIW, Ottawa (CA)

(21) Appl. No.: 18/960,764

(22) Filed: Nov. 26, 2024

Related U.S. Application Data
(60) Provisional application No. 63/708,584, filed on Oct. 17, 2024.

(51) Int. Cl. G01S 7/481; G01B 11/24

(52) U.S. Cl. CPC G01S 7/4817; G01B 11/24; G01S 7/4814

(57) ABSTRACT

A beam scanning system includes a light transmitter configured to transmit a light beam; a beam scanner configured to receive the light beam from the light transmitter and direct the light beam along an optical path according to a two-dimensional scanning pattern; and a focusing system arranged on the optical path. The focusing system includes a focusing lens configured to receive the light beam and produce a focused light beam that is focused onto an optical axis at a focal distance, wherein the focusing lens is positionally fixed; and a focus adjustment optical element arranged on the optical path, downstream from the focusing lens. The focus adjustment optical element is moveable along a translation axis that is perpendicular to the optical axis. The focus adjustment optical element is configured to adjust the focal distance based on a position of the focus adjustment optical element on the translation axis.

### CROSS-REFERENCE TO RELATED APPLICATION

This Patent Application claims priority to U.S. Provisional Patent Application No. 63/708,584, filed on Oct. 17, 2024, and entitled “TARGET DISTANCE AND FOCUS TUNING MECHANISM FOR LASER SCANNING SENSOR.” The disclosure of the prior Application is considered part of and is incorporated by reference into this Patent Application.

### TECHNICAL FIELD

The present disclosure relates generally to laser scanning sensors.

### BACKGROUND

A scanning system may use three-dimensional (3D) scanning to scan one or more light beams within a field-of-view (FOV) according to a scanning pattern. The scanning system may use two scanning axes, including a first scanning axis that is configured to steer the one or more light beams in a first direction at a first scanning frequency and a second scanning axis that is configured to steer the one or more light beams in a second direction at a second scanning frequency. The second scanning axis is typically perpendicular to the first scanning axis. Thus, the two scanning axes may provide two-dimensional (2D) scanning. In some cases, the scanning system may adjust a focal plane of the one or more light beams to target one or more distances. Thus, focal plane adjustment adds a third dimension for 3D scanning. Transmitted light beams may be reflected back to the scanning system from one or more objects in the FOV as reflected light beams. A 3D image of a scanned scene or a scanned object can then be generated based on distance measurements corresponding to the transmitted/reflected light beams. Additionally, or alternatively, the reflected light beams may be used by the scanning system to detect objects within the FOV for further processing.

### SUMMARY

In some implementations, a beam scanning system includes a light transmitter configured to transmit a light beam; a beam scanner configured to receive the light beam from the light transmitter and direct the light beam along an optical path according to a two-dimensional scanning pattern; and a focusing system arranged on the optical path, wherein the focusing system comprises: a focusing lens configured to receive the light beam and produce a focused light beam that is focused onto an optical axis at a focal distance, wherein the focusing lens is positionally fixed; and a focus adjustment optical element arranged on the optical path, downstream from the focusing lens, wherein the focus adjustment optical element is moveable along a translation axis that is substantially perpendicular to the optical axis, and wherein the focus adjustment optical element is configured to adjust the focal distance based on a position of the focus adjustment optical element on the translation axis.

In some implementations, a method of beam scanning includes generating, by a light transmitter, a light beam; directing, by a beam scanner, the light beam along an optical path according to a two-dimensional scanning pattern; focusing, by a focusing lens arranged on the optical path, the light beam at an optical axis; and adjusting, by a focus adjustment optical element arranged on the optical path, a focal distance of the light beam, including moving the focus adjustment optical element along a translation axis that is substantially perpendicular to the optical axis, wherein the focal distance is adjusted based on a position of the focus adjustment optical element on the translation axis.

In some implementations, a beam focusing system includes a focusing lens arranged on an optical path, the focusing lens configured to receive a light beam and produce a focused light beam that is focused onto an optical axis at a focal distance, wherein the focusing lens is positionally fixed; a focus adjustment optical element arranged on the optical path, downstream from the focusing lens; and a translation stage coupled to the focus adjustment optical element, wherein the translation stage is configured to move along a translation axis for adjusting a position of the focus adjustment optical element on the translation axis, and wherein the focus adjustment optical element is configured to adjust the focal distance based on the position of the focus adjustment optical element on the translation axis.

### BRIEF DESCRIPTION OF THE DRAWINGS

FIGS. 1A and 1B show a beam focusing system according to one or more implementations.

FIG. 1C shows the beam focusing system of FIGS. 1A and 1B with a reference mirror.

FIGS. 2A and 2B show a beam focusing system according to one or more implementations.

FIG. 3 shows a light beam scanning system according to one or more implementations.

FIG. 4 is a flowchart of an example process associated with a target distance and focus tuning mechanism for a laser scanning sensor.

### DETAILED DESCRIPTION

The following detailed description of example implementations refers to the accompanying drawings. The same reference numbers in different drawings may identify the same or similar elements.

Optical sensors are widely used to retrieve a 3D geometry of objects using a variety of approaches such as direct or indirect time-of-flight, structured light, and frequency chirping. For scanning-type sensors, a laser beam is swept across an object while performing distance measurements to generate a profile or a 2D mapping of the object. The performance of a sensor may rely on focusing on a target at a given distance to convert distance and angle measurements into an accurate representation of the object. Furthermore, a target distance varies from one application to another, and therefore the need for an adjustable focusing distance from the sensor to the object is required.

A sensor utilizing a laser scanner often uses an optical system, 2D beam scanners (e.g., galvanometers with mirrors or microelectromechanical system (MEMS) mirrors), and a beam focusing mechanism. To optimize received signal power, a target object should be placed at a focal plane of the sensor to maximize an amount of reflected scattered light (e.g. to maximize a return signal). Maximizing the return signal improves the precision of the optical path range from the sensor to the target object, which is then used to create a 3D representation of the target object. In many sensors, the beam focusing mechanism shifts the focal plane of the sensor by moving one or more optical components by using a linear translation (moving) stage. In addition, a reference moving stage is often required to bring a reflector optical element into an optical path of a beam. The reflector optical element may be positioned to retro-reflect the beam back toward a receiver in order for the receiver to generate a reference measurement that may be used for calibration. Thus, typical sensors have at least two linear translation stages, including at least one linear translation stage for positioning a beam focusing mechanism and another linear translation stage for positioning the reflector optical element. High precision compact linear translation stages are expensive and bulky. The number of moving stages often increases the overall cost of the sensor, adds points of failure, limits the sensor's reliability and lifetime, and requires complicated designs to mitigate environmental sensitivities. Often, the beam focusing mechanism moves in a direction orthogonal to the reference moving stage. As a result, combining the two orthogonal motions, and therefore eliminating one moving stage, requires complicated opto-mechanical systems which also increase cost, add design complexity, and limit the lifetime of the sensor.

Some implementations described herein provide a laser beam scanning system that includes a sensor having a focusing mechanism arranged on an optical path. The focusing mechanism may include a focusing lens configured to receive a light beam and produce a focused light beam that is focused onto an optical axis at a focal distance. The focusing lens may be positionally fixed. In addition, the focusing mechanism may include a focus adjustment optical element arranged on the optical path, downstream from the focusing lens. The focus adjustment optical element may be moveable along a translation axis that is perpendicular to the optical axis. Thus, the translation axis may be perpendicular to a beam propagation direction of the light beam. The focusing mechanism may adjust the focal distance based on a position of the focus adjustment optical element on the translation axis. The focus adjustment optical element may be optically transparent such that the light beam passes through the focus adjustment optical element. The focus adjustment optical element may have a variable thickness in a dimension that extends parallel to the optical axis, and an amount of focal shift of the focal distance may be a function of the position of the focus adjustment optical element on the translation axis. In other words, as the focus adjustment optical element moves along the translation axis, a thickness of the focus adjustment optical element located within the optical path may change. In some examples, the amount of focal shift of the focal distance may be a function of the variable thickness.

Thus, the focus adjustment optical element is arranged in an intermediate image space of the sensor where a laser beam is focused by the focusing lens. The introduction of an optical material in a focused beam path will cause the sensor's focal plane (e.g., the sensor's focal distance) to be shifted. An amount of focal shift is a function of optical thickness, which is a combination of a refractive index and physical thickness of the optical material. A position of the focus adjustment optical element may be adjusted to enable continuous focus adjustment or continuous focal plane tuning.

In some implementations, the focus adjustment optical element may include one or more angled facets that define the physical thickness of the focus adjustment optical element, and thereby define the optical thickness of the focus adjustment optical element. For example, the focus adjustment optical element may have a wedge shape that may enable continuous or gradual adjustment of the focal plane as the focus adjustment optical element moves along the translation axis.

In some implementations, the focus adjustment optical element may include two or more parts, such as two or more optical substrates, with different thicknesses to be bonded together to provide a discrete tuning of the sensor's focal plane. For example, an optical thickness of the focus adjustment optical element positioned within the optical path may change incrementally as different optical substrates are moved within the optical path in accordance with the movement of the focus adjustment optical element along the translation axis.

In addition, a reference mirror that faces the focusing lens may be coupled to a portion of the focus adjustment optical element. Thus, the reference mirror may move along with the focus adjustment optical element. As a result, the reference mirror may be moved into the optical path by positioning the focus adjustment optical element in a predefined position along the translation axis. The reference mirror may be configured to, based on the reference mirror being positioned in the optical path, retroreflect the light beam for a reference path length measurement. Since focal plane tuning is achieved in a lateral direction with respect to a beam propagation of the light beam, the focus adjustment optical element and the reference mirror can use a same moving mechanism (e.g., a same linear translation stage), thus eliminating a need for an additional moving stage. In other words, only one moving mechanism or linear translation stage may be used.

In summary, one or more implementations may include an optical component with a variable thickness arranged at a focused region of a sensor's optical path such that, when translated across a laser beam, the optical component shifts the sensor's focal plane. The optical component with a variable thickness may be a glass wedge element that allows for a continuous focal plane adjustment, a stack of optical plates that allows for a discrete focal plane adjustment, or a combination of the glass wedge element and the stack of optical plates. To minimize a thickness of the optical component, the optical component may be made of an optical material that has a high refractive index, such as one or more high refractive index glasses, polymers, or semiconductors that are transparent at a wavelength of interest (e.g., 1550 nanometers (nm)).

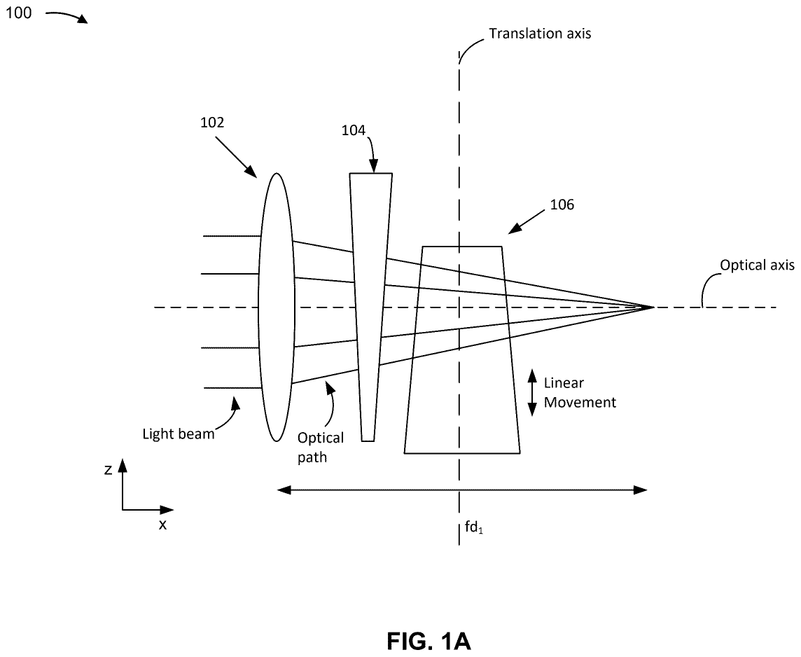

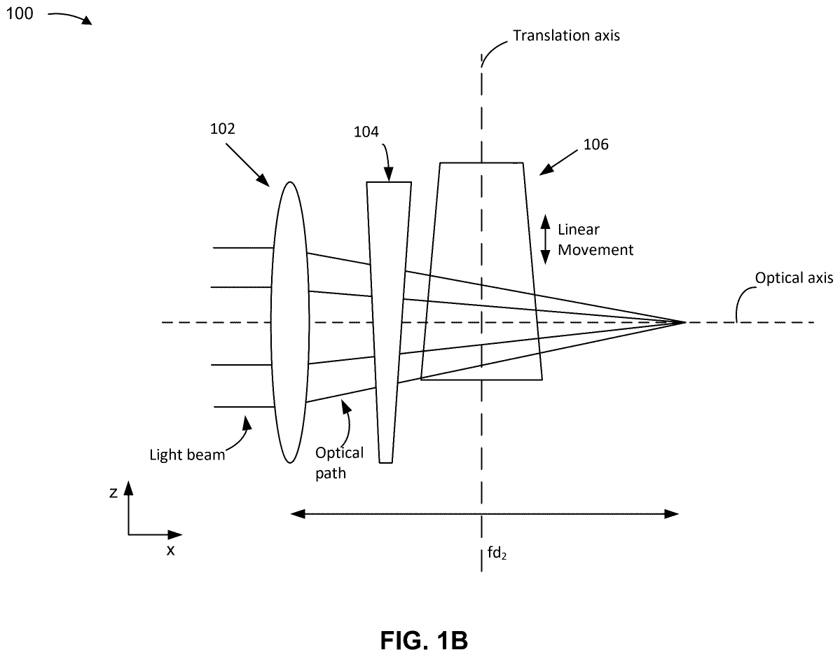

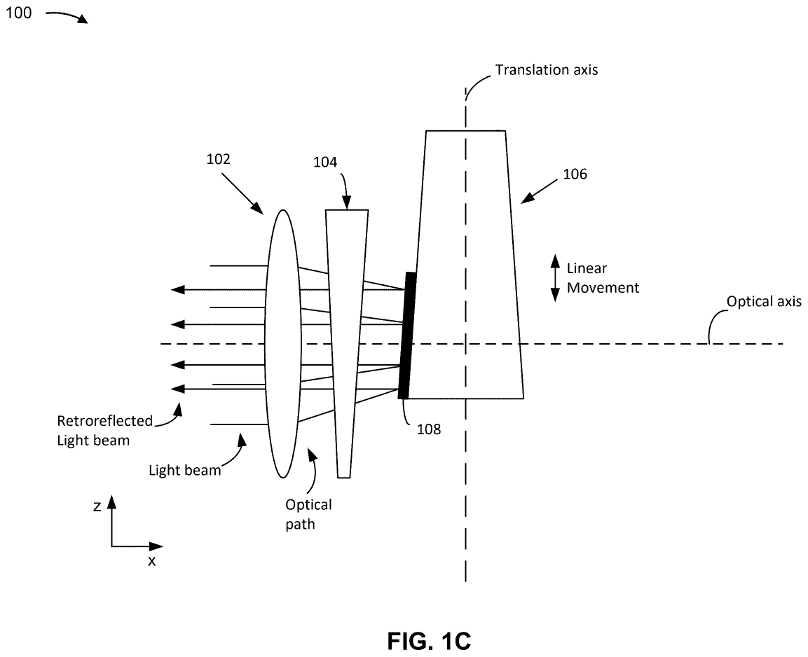

FIGS. 1A and 1B show a beam focusing system 100 according to one or more implementations. The beam focusing system 100 may include a focusing lens 102, an angle compensating optical element 104, and a focus adjustment optical element 106. The beam focusing system 100 may be part of a beam scanning system that includes a light transmitter configured to transmit a light beam (e.g., a laser beam), and a beam scanner configured to receive the light beam from the light transmitter and direct the light beam along an optical path according to a two-dimensional scanning pattern. The beam scanner may be a galvanometer mirror, a MEMS mirror, or another type of scanning mirror. The beam focusing system 100 may be arranged on the optical path, downstream from the beam scanner. In some implementations, the beam focusing system 100 may part of an optical sensor that is used to obtain measurements of one or more objects located in the FOV.

The focusing lens 102 may receive the light beam and produce a focused light beam that is focused onto an optical axis at a focal distance. The focusing lens 102 may be positionally fixed in a fixed position. The focal distance may correspond to a focal plane of the beam focusing system 100. To optimize received signal power, the focal plane should be placed at a surface of a target object in order to maximize an amount of reflected scattered light (e.g., to maximize a return signal). Maximizing the return signal may improve a precision of an optical path range from the optical sensor to the target object, which is then used to create a 3D representation of the target object.

The focus adjustment optical element 106 may be arranged on the optical path, downstream from the focusing lens 102. In some implementations, the angle compensating optical element 104 is arranged on the optical path, between the focusing lens 102 and the focus adjustment optical element 106. The focus adjustment optical element 106 may be moveable along a translation axis that is substantially perpendicular to the optical axis. Thus, the translation axis may be perpendicular to a beam propagation direction of the light beam. For example, the focus adjustment optical element 106 may be coupled to a linear translation stage that moves bidirectionally along the translation axis. The beam focusing system 100 may include a controller (not illustrated) configured to control a movement of the linear translation stage along the translation axis in order to focus the focused light beam onto a target object.

For illustrative purposes, the optical axis may correspond to an x-axis, and the translation axis may correspond to a z-axis. Since the translation axis is perpendicular (or substantially perpendicular) to the optical axis, the focus adjustment optical element 106 may be configured to move across the optical axis (e.g., across the optical path). The focus adjustment optical element 106 may adjust the focal distance based on a position of the focus adjustment optical element 106 on the translation axis. As a result, the focus adjustment optical element 106 may adjust the focal distance (e.g., the focal plane) to coincide with the surface of the target object.

The angle compensating optical element 104 may be positionally fixed. In addition, the angle compensating optical element 104 may compensate for an angular offset (e.g., angular tilt) of the focused light beam from the optical axis introduced by the focus adjustment optical element 106. For example, without the angle compensating optical element 104, the focus adjustment optical element 106 may cause the focused light beam to deviate from the optical axis at an offset angle. The angle compensating optical element 104 may cause the focused light beam to deviate from the optical axis at an offset angle that is opposite to the offset angle associated with the focus adjustment optical element 106 to cancel out the angular offset. Thus, the angle compensating optical element 104 may help to maintain the focal point on the optical axis. In other words, the angle compensating optical element 104 may cause the focused light beam to converge on the optical axis at a focal plane corresponding to the focal distance.

The focus adjustment optical element 106 may be optically transparent such that the focused light beam passes through the focus adjustment optical element 106 in a thickness dimension. For example, the focus adjustment optical element 106 may be made of glass. The focused light beam may enter the focus adjustment optical element 106 at a frontside of the focus adjustment optical element 106, and may exit the focus adjustment optical element 106 at a backside of the focus adjustment optical element 106. For example, the thickness dimension may extend along the x-axis, parallel to the optical axis. The focus adjustment optical element 106 may have a variable thickness in the thickness dimension. An amount of focal shift of the focal distance may be a function of the variable thickness.

In some examples, the focus adjustment optical element 106 has an optical thickness, along the optical path, defined by a physical thickness of the focus adjustment optical element 106 and a refractive index of the focus adjustment optical element 106. Thus, the optical thickness may be varied by varying the physical thickness, varying the refractive index, or varying both the physical thickness and the refractive index. The optical thickness along the optical path may vary based on the position of the focus adjustment optical element 106 on the translation axis. In other words, the focus adjustment optical element 106 may have a variable optical thickness, and the optical thickness along the optical path may depend on the position of the focus adjustment optical element 106 on the translation axis. The focus adjustment optical element 106 may adjust the focal distance based on the optical thickness along the optical path.

In some implementations, the focus adjustment optical element 106 may have one or more angled facets that define the optical thickness. For example, the focus adjustment optical element 106 may have a first wedge shape that tapers in a first direction (e.g., a positive z-direction) parallel to the translation axis. As the focus adjustment optical element 106 moves along the translation axis, the optical thickness along the optical path continuously changes. Thus, the first wedge shape may allow for a continuous focal plane adjustment as the focus adjustment optical element 106 moves across the optical axis.

The angle compensating optical element 104 may have a second wedge shape that tapers in a second direction (e.g., a negative z-direction) parallel to the translation axis, the second direction being opposite to the first direction. In other words, the angle compensating optical element 104 and the focus adjustment optical element 106 may taper in opposite directions. In this way, the angle compensating optical element 104 may compensate for the angular offset of the focused light beam from the optical axis caused by the focus adjustment optical element 106.

FIGS. 1A and 1B show the focus adjustment optical element 106 arranged at different positions on the translation axis. As a result, the optical thickness of the focus adjustment optical element 106 along the optical axis in FIG. 1A is smaller than the optical thickness of the focus adjustment optical element 106 along the optical axis in FIG. 1B. The different optical thickness causes a shift in the focal distance of the focused light beam. For example, in FIG. 1A, the focus adjustment optical element 106 may provide a first focal distance fd1, and, in FIG. 1B, the focus adjustment optical element 106 may provide a second focal distance fd2 that is greater than the first focal distance fd1. A thinner part of the focus adjustment optical element 106 moves the focal plane of the focusing lens 102 closer to the beam focusing system 100, represented by the first focal distance fd1. In contrast, as the focus adjustment optical element 106 moves across the light beam, a thicker part of the focus adjustment optical element 106 moves the focal plane of the focusing lens 102 away from the beam focusing system 100, represented by the second focal distance fd2. Thus, the focus adjustment optical element 106 converts linear motion of the focus adjustment optical element 106 to a change in a focal position of the beam focusing system 100.

As indicated above, FIGS. 1A and 1B are provided as examples. Other examples may differ from what is described with regard to FIGS. 1A and 1B.

FIG. 1C shows the beam focusing system 100 with a reference mirror 108. The reference mirror 108 may face the focusing lens 102. The reference mirror 108 may, based on the reference mirror 108 being positioned in the optical path, retroreflect the focused light beam for a reference path length measurement. For example, a sensor (not illustrated) may be arranged along a reflected path of the focused light beam. Thus, the sensor may receive the focused light beam, retroreflected by the reference mirror 108, and generate the reference path length measurement for calibrating measurements obtained at the focal distance. The reference path length measurement may be used to compensate for shifts in an optical path length caused by changes in temperature, aging effects, and other external influences.

The reference mirror 108 may cover only a portion of the focus adjustment optical element 204 such that light beams are reflected only when the focus adjustment optical element 204 is positioned in such a way that reference mirror 108 receives the light beams. The focus adjustment optical element 204 may be positioned such that light is not incident on the reference mirror 108 and passes through the focus adjustment optical element 204.

The reference mirror 108 may be coupled to a portion of the frontside of the focus adjustment optical element 106. In other words, the reference mirror 108 may cover only a portion of the focus adjustment optical element 106 such that light beams are reflected only when the focus adjustment optical element 106 is positioned in such a way that reference mirror 108 receives the light beams. The focus adjustment optical element 106 may positioned such that light is not incident on the reference mirror 108 and passes through the focus adjustment optical element 106 for an object scanning operation.

The reference mirror 108 may move along with the focus adjustment optical element 106. As a result, the reference mirror 108 may be moved into the optical path by positioning the focus adjustment optical element 106 in a predefined position along the translation axis. The reference mirror 108 may be configured to, based on the reference mirror 108 being positioned in the optical path, retroreflect the focused light beam for the reference path length measurement. Since focal plane tuning is achieved in a lateral direction with respect to a beam propagation of the light beam, the focus adjustment optical element 106 and the reference mirror 108 can use a same moving mechanism (e.g., a same linear translation stage), thus eliminating a need for an additional moving stage. In other words, only one moving mechanism or linear translation stage may be used for moving both the focus adjustment optical element 106 and the reference mirror 108, eliminating a need for an additional translation stage.

As indicated above, FIG. 1C is provided as an example. Other examples may differ from what is described with regard to FIG. 1C.

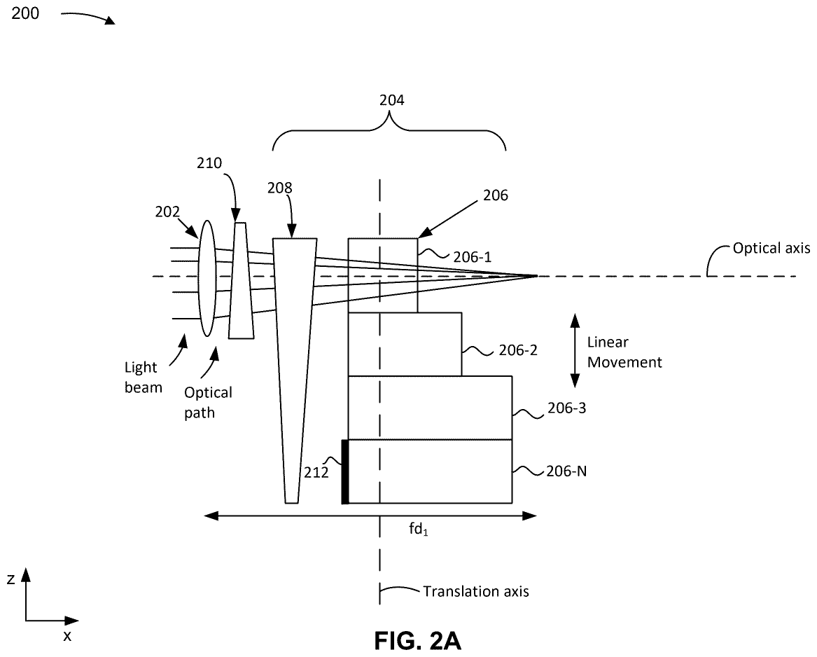

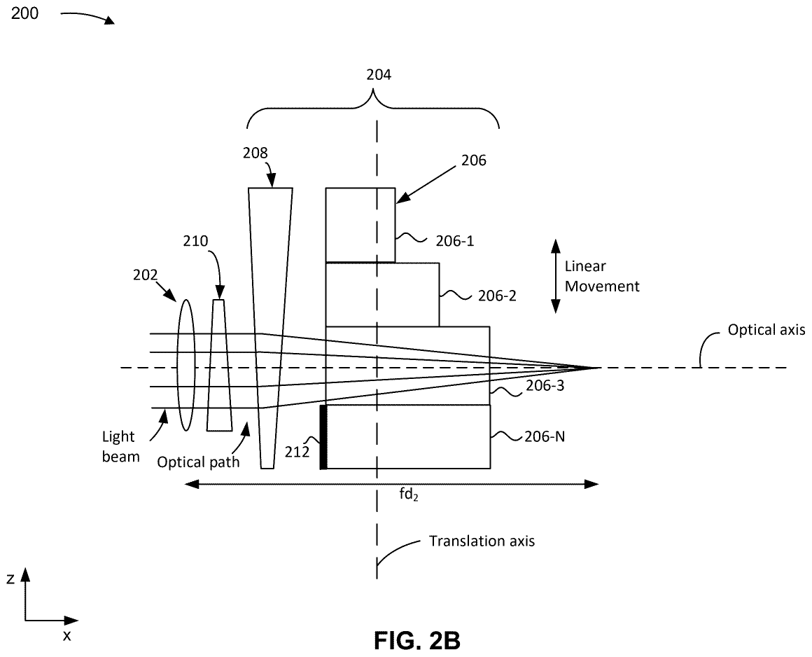

FIGS. 2A and 2B show a beam focusing system 200 according to one or more implementations. The beam focusing system 200 may include a focusing lens 202, a focus adjustment optical element 204 that includes a coarse focus adjustment optical element 206 and a fine focus adjustment optical element 208, an angle compensating optical element 210, and a reference mirror 212. The beam focusing system 200 may be part of a beam scanning system that includes a light transmitter configured to transmit a light beam, and a beam scanner configured to receive the light beam from the light transmitter and direct the light beam along an optical path according to a two-dimensional scanning pattern. The beam scanner may be a galvanometer mirror, a MEMS mirror, or another type of scanning mirror. The beam focusing system 200 may be arranged on the optical path, downstream from the beam scanner. In some implementations, the beam focusing system 200 may part of an optical sensor that is used to obtain measurements of one or more objects located in the FOV.

The focusing lens 202 may receive the light beam and produce a focused light beam that is focused onto an optical axis at a focal distance. The focusing lens 202 may be positionally fixed. The focal distance may correspond to a focal plane of the beam focusing system 200. To optimize received signal power, the focal plane should be placed at a surface of a target object in order to maximize an amount of reflected scattered light (e.g., to maximize a return signal). Maximizing the return signal may improve a precision of an optical path range from the optical sensor to the target object, which is then used to create a 3D representation of the target object.

The focus adjustment optical element 204 may be arranged on the optical path, downstream from the focusing lens 202. In some implementations, the coarse focus adjustment optical element 206 may be arranged downstream from the fine focus adjustment optical element 208. In addition, the angle compensating optical element 210 may be arranged on the optical path, between the focusing lens 202 and the focus adjustment optical element 204. The focus adjustment optical element 204 may be moveable along a translation axis that is substantially perpendicular to the optical axis. Thus, the coarse focus adjustment optical element 206 and the fine focus adjustment optical element 208 may be moveable along the translation axis. The focus adjustment optical element 204 may be coupled to a linear translation stage that moves bidirectionally along the translation axis. Both the coarse focus adjustment optical element 206 and the fine focus adjustment optical element 208 may be coupled to the linear translation stage for co-dependent movement. The beam focusing system 200 may include a controller (not illustrated) configured to control a movement of the linear translation stage along the translation axis in order to focus the focused light beam onto a target object.

Since the translation axis is perpendicular (or substantially perpendicular) to the optical axis, the focus adjustment optical element 204 may be configured to move across the optical axis (e.g., across the optical path). Since both the coarse focus adjustment optical element 206 and the fine focus adjustment optical element 208 move together, the positions of the coarse focus adjustment optical element 206 and the fine focus adjustment optical element 208 may be shifted together along the translation axis. The focus adjustment optical element 204 may adjust the focal distance based on a position of the focus adjustment optical element 204 on the translation axis (e.g., based on the positions of the coarse focus adjustment optical element 206 and the fine focus adjustment optical element 208 on the translation axis). As a result, the focus adjustment optical element 204 may adjust the focal distance (e.g., the focal plane) to coincide with the surface of the target object.

The angle compensating optical element 210 may be positionally fixed. In addition, the angle compensating optical element 210 may compensate for an angular offset of the focused light beam from the optical axis introduced by the fine focus adjustment optical element 208. For example, without the angle compensating optical element 210, the fine focus adjustment optical element 208 may cause the focused light beam to deviate from the optical axis at an offset angle. The angle compensating optical element 210 may cause the focused light beam to deviate from the optical axis at an offset angle that is opposite to the offset angle associated with the fine focus adjustment optical element 208, to cancel out the angular offset. Thus, the angle compensating optical element 210 may help to maintain the focal point on the optical axis. In other words, the angle compensating optical element 210 may cause the focused light beam to converge on the optical axis at a focal plane corresponding to the focal distance.

The coarse focus adjustment optical element 206 and the fine focus adjustment optical element 208 may be optically transparent such that the focused light beam passes through the focus adjustment optical element 204 in a thickness dimension. The focus adjustment optical element 204 may have a variable thickness in the thickness dimension. An amount of focal shift of the focal distance may be a function of the variable thickness. The coarse focus adjustment optical element 206 and the fine focus adjustment optical element 208 may both have variable thicknesses in the thickness dimension. The coarse focus adjustment optical element 206 may be configured to provide larger adjustments (e.g., larger focal shifts) of the focal distance compared to the fine focus adjustment optical element 208. Thus, the coarse focus adjustment optical element 206 may be used for coarse tuning of the focal distance, whereas the fine focus adjustment optical element 208 may be used for fine tuning of the focal distance.

In some examples, the focus adjustment optical element 204 has an optical thickness, along the optical path, defined by a physical thickness of the focus adjustment optical element 204 and a refractive index of the focus adjustment optical element 204. Thus, the optical thickness may be varied by varying the physical thickness, varying the refractive index, or varying both the physical thickness and the refractive index. The optical thickness along the optical path may vary based on the position of the focus adjustment optical element 204 on the translation axis. In other words, the focus adjustment optical element 204 may have a variable optical thickness, and the optical thickness along the optical path may depend on the position of the focus adjustment optical element 204 on the translation axis. The focus adjustment optical element 204 may adjust the focal distance based on the optical thickness along the optical path.

The coarse focus adjustment optical element 206 and the fine focus adjustment optical element 208 may each have a respective optical thickness, along the optical path, that varies based on the position of the focus adjustment optical element 204 on the translation axis. In some implementations, the coarse focus adjustment optical element 206 may include a plurality of optical elements 206-1, 206-2, and 206-3 arranged in a stack. The optical elements 206-1, 206-2, and 206-3 may be glass elements. The coarse focus adjustment optical element 206 may also include an optical element 206-N, arranged in the stack, to which the reference mirror 212 is coupled. The plurality of optical elements 206-1, 206-2, and 206-3 may be optical plates, bonded together, that allow for a discrete focal plane adjustment. Each optical element 206-1, 206-2, and 206-3 of the plurality of optical elements may have a different optical thickness in a thickness dimension that extends parallel to the optical axis. While the optical elements 206-1, 206-2, and 206-3 are shown in FIGS. 2A and 2B as having different physical thicknesses, different optical thicknesses may be achieved with different physical thicknesses, different refractive indices, or a combination of different physical thicknesses and different refractive indices.

The fine focus adjustment optical element 208 may include one or more angled facets that define the variable thickness of the fine focus adjustment optical element 208. Thus, the one or more angled facets may define the optical thickness of the fine focus adjustment optical element 208. As the fine focus adjustment optical element 208 moves along the translation axis, the optical thickness of the fine focus adjustment optical element 208 along the optical path continuously changes. In some examples, the fine focus adjustment optical element 208 may have a first wedge shape that tapers in a first direction parallel to the translation axis. As the fine focus adjustment optical element 208 moves along the translation axis, the optical thickness of the fine focus adjustment optical element 208, along the optical path, changes. The fine focus adjustment optical element 208 may have different tapered sections that correspond to each optical element 206-1, 206-2, and 206-3. Thus, the fine focus adjustment optical element 208 may be used to fine tune a coarse focal adjustment provided by a respective optical element 206-1, 206-2, and 206-3.

The angle compensating optical element 210 may have a second wedge shape that tapers in a second direction parallel to the translation axis, the second direction being opposite to the first direction. In other words, the angle compensating optical element 104 and the fine focus adjustment optical element 208 may taper in opposite directions. In this way, the angle compensating optical element 104 may compensate for the angular offset of the focused light beam from the optical axis caused by the fine focus adjustment optical element 208.

A stacked profile of the optical elements 206-1, 206-2, and 206-3 of the coarse focus adjustment optical element 206 may narrow in the second direction parallel to the translation axis. In other words, the stacked profile may narrow in an opposite direction to the direction along which the fine focus adjustment optical element 208 narrows. The stacked profile may narrow in a same direction to the direction along which the angle compensating optical element 210 narrows. From top to bottom, the optical elements 206-1, 206-2, and 206-3 of the coarse focus adjustment optical element 206 may provide a progressively longer focus adjustment, with a top optical element 206-1 providing a shortest focal distance (e.g., fd1) and a bottom optical element 206-3 providing a longest focal distance (e.g., fd2). Thus, the optical elements 206-1, 206-2, and 206-3 of the coarse focus adjustment optical element 206 may have different thicknesses, which are used for discrete coarse focus adjustment. When the coarse focus adjustment optical element 206 is moved across the light beam, the focal plane discretely shifts position based on the thickness of an optical element 206-1, 206-2, or 206-3 that is in the optical path of the light beam.

The reference mirror 212 may face the focusing lens 102. The reference mirror 212 may, based on the reference mirror 212 being positioned in the optical path, retroreflect the focused light beam for a reference path length measurement. For example, a sensor (not illustrated) may be arranged along a reflected path of the focused light beam. Thus, the sensor may receive the focused light beam, retroreflected by the reference mirror 212, and generate the reference path length measurement for calibrating measurements obtained at the focal distance. The reference path length measurement may be used to compensate for shifts in an optical path length caused by changes in temperature, aging effects, and other external influences.

The reference mirror 212 may be coupled to a portion of the frontside of the coarse focus adjustment optical element 206. For example, the reference mirror 212 may be coupled to the front side of the optical element 206-N. Thus, the reference mirror 212 may move along with the focus adjustment optical element 204. As a result, the reference mirror 212 may be moved into the optical path by positioning the focus adjustment optical element 204 in a predefined position along the translation axis. The reference mirror 212 may be configured to, based on the reference mirror 212 being positioned in the optical path, retroreflect the focused light beam for the reference path length measurement. Since focal plane tuning is achieved in a lateral direction with respect to a beam propagation of the light beam, the focus adjustment optical element 204 and the reference mirror 212 can use a same moving mechanism (e.g., a same linear translation stage), thus eliminating a need for an additional moving stage. In other words, only one moving mechanism or linear translation stage may be used for moving both the focus adjustment optical element 204 and the reference mirror 212.

FIGS. 2A and 2B show the focus adjustment optical element 204 arranged at different positions on the translation axis. As a result, the optical thickness of the focus adjustment optical element 204 along the optical axis in FIG. 2A is smaller than the optical thickness of the focus adjustment optical element 204 along the optical axis in FIG. 2B. The different optical thickness causes a shift in the focal distance of the focused light beam. For example, in FIG. 2A, the focus adjustment optical element 204 may provide a first focal distance fd1, and, in FIG. 2B, the focus adjustment optical element 204 may provide a second focal distance fd2 that is greater than the first focal distance fd1.

As indicated above, FIGS. 2A and 2B are provided as examples. Other examples may differ from what is described with regard to FIGS. 2A and 2B.

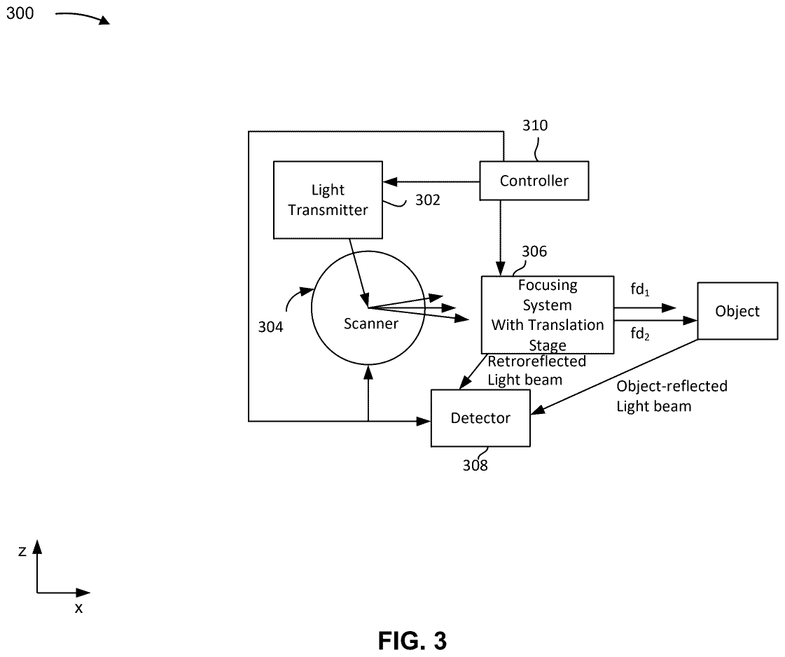

FIG. 3 shows a light beam scanning system 300 according to one or more implementations. The light beam scanning system 300 may include a light transmitter 302, a beam scanner 304, a beam focusing system 306, a detector 308 (e.g., an optical sensor), and a controller 310. The light transmitter 302 may transmit one or more light beams toward the beam scanner 304. In some implementations, the light transmitter 302 may transmit a continuous-wave light beam. In some implementations, the light transmitter 302 may transmit light pulses. The beam scanner 304 may rotate about one or more scanning axes to steer the one or more light beams in an x-direction and/or y-direction. The beam focusing system 306 may correspond to a beam focusing system 100 or 200 described above. Additionally, the beam focusing system 306 may include a translation stage coupled to a focus adjustment optical element. The translation stage may move along a translation axis for adjusting a position of the focus adjustment optical element on the translation axis, as described elsewhere herein.

The beam focusing system 306 may focus the one or more light beams onto a target object at respective desired focal distances. The one or more light beams may reflect off the target object and return to the detector 308 for angle and distance measurements to generate a 3D representation of the target object. In addition, the detector 308 may be used for obtaining one or more reference path length measurements. For example, the detector 308 may receive a light beam, retroreflected by a reference mirror of the beam focusing system 306, and generate the reference path length measurement for calibrating measurements obtained at the focal distance.

The controller 310 may control the light transmitter 302, the beam scanner 304, the beam focusing system 306, and/or the detector 308 via one or more control signals. The controller 310 may control a movement of the translation stage along the translation axis in order to move the focus adjustment optical element and to focus the light beam onto a target object.

As indicated above, FIG. 3 is provided as an example. Other examples may differ from what is described with regard to FIG. 3.

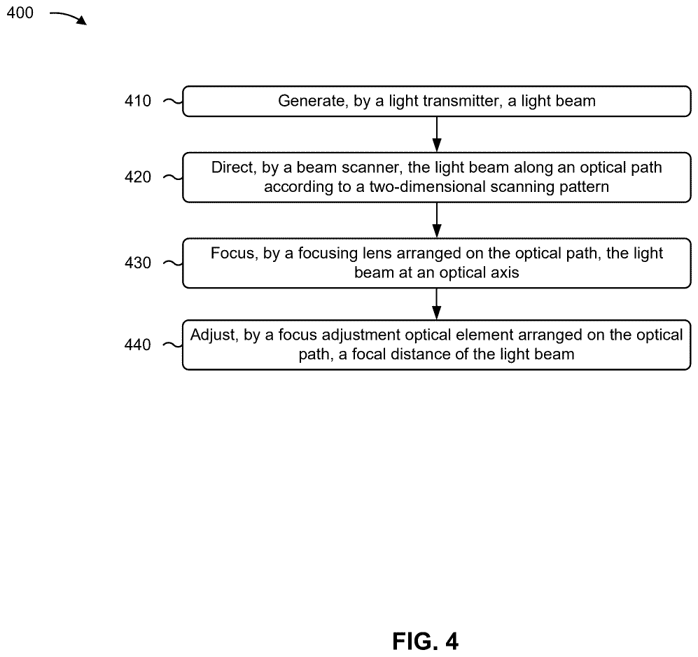

FIG. 4 is a flowchart of an example process 400 associated with a target distance and focus tuning mechanism for a laser scanning sensor. In some implementations, one or more process blocks of FIG. 4 are performed by a beam focusing system (e.g., beam focusing system 100, beam focusing system 200, or beam focusing system 306). In some implementations, one or more process blocks of FIG. 4 are performed by another device or a group of devices separate from or including the beam focusing system, such as a light transmitter (e.g., light transmitter 302), a beam scanner (e.g., beam scanner 304), a detector (e.g., detector 308), and/or a controller (e.g., controller 310). Additionally, or alternatively, one or more process blocks of FIG. 4 may be performed by one or more components of the beam focusing system, such as a focusing lens and/or one or more focus adjustment optical elements.

As shown in FIG. 4, process 400 may include generating a light beam (block 410). For example, a light transmitter may generate a light beam, as described above.

As further shown in FIG. 4, process 400 may include directing the light beam along an optical path according to a two-dimensional scanning pattern (block 420). For example, a beam scanner may direct the light beam along the optical path according to the two-dimensional scanning pattern, as described above.

As further shown in FIG. 4, process 400 may include focusing the light beam at an optical axis (block 430). For example, a focusing element, such as a focusing lens, may focus the light beam at the optical axis, as described above.

As further shown in FIG. 4, process 400 may include adjusting a focal distance of the light beam (block 440). For example, a focus adjustment optical element may adjust the focal distance of the light beam, as described above. Adjusting the focal distance of the light beam may include moving the focus adjustment optical element along a translation axis that is substantially perpendicular to the optical axis such that the focal distance is adjusted based on a position of the focus adjustment optical element on the translation axis.

Process 400 may include additional implementations, such as any single implementation or any combination of implementations described below and/or in connection with one or more other processes described elsewhere herein.

In a first implementation, adjusting the focal distance of the light beam may include converting a linear motion of the focus adjustment optical element along a translation axis into a change in the focal distance.

In a second implementation, the focus adjustment optical element may have an optical thickness, within the optical path, that varies based on the position of the focus adjustment optical element on the translation axis, and adjusting the focal distance of the light beam includes shifting which portion of the focus adjustment optical element is arranged within the optical path.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The following provides an overview of some Aspects of the present disclosure:

Aspect 1: A beam scanning system, comprising: a light transmitter configured to transmit a light beam; a beam scanner configured to receive the light beam from the light transmitter and direct the light beam along an optical path according to a two-dimensional scanning pattern; and a focusing system arranged on the optical path, wherein the focusing system comprises: a focusing lens configured to receive the light beam and produce a focused light beam that is focused onto an optical axis at a focal distance, wherein the focusing lens is positionally fixed; and a focus adjustment optical element arranged on the optical path, downstream from the focusing lens, wherein the focus adjustment optical element is moveable along a translation axis that is substantially perpendicular to the optical axis, and wherein the focus adjustment optical element is configured to adjust the focal distance based on a position of the focus adjustment optical element on the translation axis.

Aspect 2: The beam scanning system of Aspect 1, wherein the focus adjustment optical element is optically transparent such that the light beam passes through the focus adjustment optical element.

Aspect 3: The beam scanning system of any of Aspects 1-2, wherein the focus adjustment optical element has a variable thickness in a dimension that extends parallel to the optical axis, and wherein an amount of focal shift of the focal distance is a function of the variable thickness.

Aspect 4: The beam scanning system of any of Aspects 1-3, wherein the focus adjustment optical element has an optical thickness, along the optical path, that varies based on the position of the focus adjustment optical element on the translation axis, and wherein the focus adjustment optical element is configured to adjust the focal distance based on the optical thickness along the optical path.

Aspect 5: The beam scanning system of Aspect 4, wherein the focus adjustment optical element has one or more angled facets that define the optical thickness.

Aspect 6: The beam scanning system of Aspect 4, further comprising: an angle compensating optical element arranged on the optical path, wherein the angle compensating optical element is positionally fixed, and wherein the angle compensating optical element is configured to compensate for an angular offset of the light beam from the optical axis caused by the focus adjustment optical element.

Aspect 7: The beam scanning system of Aspect 6, wherein the angle compensating optical element is configured to cause the light beam to converge on the optical axis at a focal plane corresponding to the focal distance.

Aspect 8: The beam scanning system of Aspect 6, wherein the focus adjustment optical element has a first wedge shape that tapers in a first direction parallel to the translation axis, and wherein the angle compensating optical element has a second wedge shape that tapers in a second direction parallel to the translation axis, the second direction being opposite to the first direction.

Aspect 9: The beam scanning system of Aspect 4, wherein the focus adjustment optical element comprises a coarse focus adjustment optical element having a plurality of optical elements arranged in a stack, wherein each optical element of the plurality of optical elements has a different optical thickness in a dimension that extends parallel to the optical axis, and wherein the focus adjustment optical element is moveable along the translation axis such that one optical element of the plurality of optical elements is arranged in the optical path.

Aspect 10: The beam scanning system of Aspect 9, wherein the focus adjustment optical element comprises a fine focus adjustment optical element having a variable thickness in a dimension that extends parallel to the optical axis, and wherein the focus adjustment optical element is moveable along the translation axis such that a thickness of the fine focus adjustment optical element, along the optical path, varies based on the position of the focus adjustment optical element on the translation axis.

Aspect 11: The beam scanning system of Aspect 10, wherein the fine focus adjustment optical element includes one or more angled facets that define the variable thickness of the fine focus adjustment optical element.

Aspect 12: The beam scanning system of Aspect 10, further comprising: an angle compensating optical element arranged on the optical path, wherein the angle compensating optical element is positionally fixed, and wherein the angle compensating optical element is configured to compensate for an angular offset of the light beam from the optical axis caused by the fine focus adjustment optical element.

Aspect 13: The beam scanning system of Aspect 12, wherein the angle compensating optical element is configured to cause the light beam to converge on the optical axis at a focal plane corresponding to the focal distance.

Aspect 14: The beam scanning system of Aspect 12, wherein the fine focus adjustment optical element has a first wedge shape that tapers in a first direction parallel to the translation axis, and wherein the angle compensating optical element has a second wedge shape that tapers in a second direction parallel to the translation axis, the second direction being opposite to the first direction.

Aspect 15: The beam scanning system of any of Aspects 1-14, wherein the focus adjustment optical element comprises a reference mirror that faces the focusing lens, and wherein the reference mirror is configured to, based on the reference mirror being positioned in the optical path, retroreflect the light beam for a reference path length measurement.

Aspect 16: The beam scanning system of Aspect 15, further comprising: a sensor configured to receive the light beam, retroreflected by the reference mirror, and generate the reference path length measurement for calibrating measurements obtained at the focal distance.

Aspect 17: The beam scanning system of any of Aspects 1-16, further comprising: a translation stage coupled to the focus adjustment optical element, wherein the translation stage is configured to move along the translation axis for adjusting the position of the focus adjustment optical element on the translation axis; and a controller configured to control a movement of the translation stage along the translation axis in order to focus the light beam onto a target object.

Aspect 18: A method of beam scanning, comprising: generating, by a light transmitter, a light beam; directing, by a beam scanner, the light beam along an optical path according to a two-dimensional scanning pattern; focusing, by a focusing lens arranged on the optical path, the light beam at an optical axis; and adjusting, by a focus adjustment optical element arranged on the optical path, a focal distance of the light beam, including moving the focus adjustment optical element along a translation axis that is substantially perpendicular to the optical axis, wherein the focal distance is adjusted based on a position of the focus adjustment optical element on the translation axis.

Aspect 19: The method of Aspect 18, wherein adjusting the focal distance of the light beam includes converting a linear motion of the focus adjustment optical element along a translation axis into a change in the focal distance.

Aspect 20: The method of any of Aspects 18-19, wherein the focus adjustment optical element has an optical thickness, within the optical path, that varies based on the position of the focus adjustment optical element on the translation axis, and wherein adjusting the focal distance of the light beam includes shifting which portion of the focus adjustment optical element is arranged within the optical path.

Aspect 21: A beam focusing system, comprising: a focusing lens arranged on an optical path, the focusing lens configured to receive a light beam and produce a focused light beam that is focused onto an optical axis at a focal distance, wherein the focusing lens is positionally fixed; a focus adjustment optical element arranged on the optical path, downstream from the focusing lens; and a translation stage coupled to the focus adjustment optical element, wherein the translation stage is configured to move along a translation axis for adjusting a position of the focus adjustment optical element on the translation axis, and wherein the focus adjustment optical element is configured to adjust the focal distance based on the position of the focus adjustment optical element on the translation axis.

Aspect 22: The beam focusing system of Aspect 21, further comprising: a controller configured to control a movement of the translation stage along the translation axis in order to focus the light beam onto a target object.

Aspect 23: The beam focusing system of any of Aspects 21-22, wherein the focus adjustment optical element has an optical thickness, along the optical path, that varies based on the position of the focus adjustment optical element on the translation axis, and wherein the focus adjustment optical element is configured to adjust the focal distance based on the optical thickness along the optical path.

Aspect 24: The beam focusing system of any of Aspects 21-23, wherein the focus adjustment optical element comprises a reference mirror that faces the focusing lens, and wherein the reference mirror is configured to, based on the reference mirror being positioned in the optical path, retroreflect the light beam for a reference path length measurement.

Aspect 25: A system configured to perform one or more operations recited in one or more of Aspects 1-24.

Aspect 26: An apparatus comprising means for performing one or more operations recited in one or more of Aspects 1-24.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A beam scanning system, comprising:
a light transmitter configured to transmit a light beam;
a beam scanner configured to receive the light beam from the light transmitter and direct the light beam along an optical path according to a two-dimensional scanning pattern; and
a focusing system arranged on the optical path, wherein the focusing system comprises:
a focusing lens configured to receive the light beam and produce a focused light beam that is focused onto an optical axis at a focal distance, wherein the focusing lens is positionally fixed; and
a focus adjustment optical element arranged on the optical path, downstream from the focusing lens,
wherein the focus adjustment optical element is moveable along a translation axis that is substantially perpendicular to the optical axis, and
wherein the focus adjustment optical element is configured to adjust the focal distance based on a position of the focus adjustment optical element on the translation axis.

2. The beam scanning system of claim 1, wherein the focus adjustment optical element is optically transparent such that the light beam passes through the focus adjustment optical element.

3. The beam scanning system of claim 1, wherein the focus adjustment optical element has a variable thickness in a dimension that extends parallel to the optical axis, and wherein an amount of focal shift of the focal distance is a function of the variable thickness.

4. The beam scanning system of claim 1, wherein the focus adjustment optical element has an optical thickness, along the optical path, that varies based on the position of the focus adjustment optical element on the translation axis, and
wherein the focus adjustment optical element is configured to adjust the focal distance based on the optical thickness along the optical path.

5. The beam scanning system of claim 4, wherein the focus adjustment optical element has one or more angled facets that define the optical thickness.

6. The beam scanning system of claim 4, further comprising:
an angle compensating optical element arranged on the optical path,
wherein the angle compensating optical element is positionally fixed, and
wherein the angle compensating optical element is configured to compensate for an angular offset of the light beam from the optical axis caused by the focus adjustment optical element.

7. The beam scanning system of claim 6, wherein the angle compensating optical element is configured to cause the light beam to converge on the optical axis at a focal plane corresponding to the focal distance.

8. The beam scanning system of claim 6, wherein the focus adjustment optical element has a first wedge shape that tapers in a first direction parallel to the translation axis, and
wherein the angle compensating optical element has a second wedge shape that tapers in a second direction parallel to the translation axis, the second direction being opposite to the first direction.

9. The beam scanning system of claim 4, wherein the focus adjustment optical element comprises a coarse focus adjustment optical element having a plurality of optical elements arranged in a stack,
wherein each optical element of the plurality of optical elements has a different optical thickness in a dimension that extends parallel to the optical axis, and
wherein the focus adjustment optical element is moveable along the translation axis such that one optical element of the plurality of optical elements is arranged in the optical path.

10. The beam scanning system of claim 9, wherein the focus adjustment optical element comprises a fine focus adjustment optical element having a variable thickness in a dimension that extends parallel to the optical axis, and
wherein the focus adjustment optical element is moveable along the translation axis such that a thickness of the fine focus adjustment optical element, along the optical path, varies based on the position of the focus adjustment optical element on the translation axis.

11. The beam scanning system of claim 10, wherein the fine focus adjustment optical element includes one or more angled facets that define the variable thickness of the fine focus adjustment optical element.

12. The beam scanning system of claim 10, further comprising:
an angle compensating optical element arranged on the optical path,
wherein the angle compensating optical element is positionally fixed, and
wherein the angle compensating optical element is configured to compensate for an angular offset of the light beam from the optical axis caused by the fine focus adjustment optical element.

13. The beam scanning system of claim 12, wherein the angle compensating optical element is configured to cause the light beam to converge on the optical axis at a focal plane corresponding to the focal distance.

14. The beam scanning system of claim 12, wherein the fine focus adjustment optical element has a first wedge shape that tapers in a first direction parallel to the translation axis, and
wherein the angle compensating optical element has a second wedge shape that tapers in a second direction parallel to the translation axis, the second direction being opposite to the first direction.

15. The beam scanning system of claim 1, wherein the focus adjustment optical element comprises a reference mirror that faces the focusing lens, and
wherein the reference mirror is configured to, based on the reference mirror being positioned in the optical path, retroreflect the light beam for a reference path length measurement.

16. The beam scanning system of claim 15, further comprising:
a sensor configured to receive the light beam, retroreflected by the reference mirror, and generate the reference path length measurement for calibrating measurements obtained at the focal distance.

17. The beam scanning system of claim 1, further comprising:
a translation stage coupled to the focus adjustment optical element,
wherein the translation stage is configured to move along the translation axis for adjusting the position of the focus adjustment optical element on the translation axis; and
a controller configured to control a movement of the translation stage along the translation axis in order to focus the light beam onto a target object.

18. A method of beam scanning, comprising:
generating, by a light transmitter, a light beam;
directing, by a beam scanner, the light beam along an optical path according to a two-dimensional scanning pattern;
focusing, by a focusing lens arranged on the optical path, the light beam at an optical axis; and
adjusting, by a focus adjustment optical element arranged on the optical path, a focal distance of the light beam, including moving the focus adjustment optical element along a translation axis that is substantially perpendicular to the optical axis,
wherein the focal distance is adjusted based on a position of the focus adjustment optical element on the translation axis.

19. The method of claim 18, wherein adjusting the focal distance of the light beam includes converting a linear motion of the focus adjustment optical element along a translation axis into a change in the focal distance.

20. The method of claim 18, wherein the focus adjustment optical element has an optical thickness, within the optical path, that varies based on the position of the focus adjustment optical element on the translation axis, and
wherein adjusting the focal distance of the light beam includes shifting which portion of the focus adjustment optical element is arranged within the optical path.

21. A beam focusing system, comprising:
a focusing lens arranged on an optical path, the focusing lens configured to receive a light beam and produce a focused light beam that is focused onto an optical axis at a focal distance, wherein the focusing lens is positionally fixed;
a focus adjustment optical element arranged on the optical path, downstream from the focusing lens; and
a translation stage coupled to the focus adjustment optical element,
wherein the translation stage is configured to move along a translation axis for adjusting a position of the focus adjustment optical element on the translation axis, and
wherein the focus adjustment optical element is configured to adjust the focal distance based on the position of the focus adjustment optical element on the translation axis.

22. The beam focusing system of claim 21, further comprising:
a controller configured to control a movement of the translation stage along the translation axis in order to focus the light beam onto a target object.

23. The beam focusing system of claim 21, wherein the focus adjustment optical element has an optical thickness, along the optical path, that varies based on the position of the focus adjustment optical element on the translation axis, and
wherein the focus adjustment optical element is configured to adjust the focal distance based on the optical thickness along the optical path.

24. The beam focusing system of claim 21, wherein the focus adjustment optical element comprises a reference mirror that faces the focusing lens, and
wherein the reference mirror is configured to, based on the reference mirror being positioned in the optical path, retroreflect the light beam for a reference path length measurement.
